(19) United States
(12) Patent Application Publication
(10) Pub. No.: US 2015/0288613 A1
(43) Pub. Date: Oct. 8, 2015

(54) PACKET SWITCH SYSTEM AND TRAFFIC CONTROL METHOD THEREOF

(71) Applicant: Electronics and Telecommunications Research Institute, Daejeon (KR)

(72) Inventors: Yool KWON, Daejeon (KR); Min Taig KIM, Daejeon (KR)

(73) Assignee: Electronics and Telecommunications Research Institute, Daejeon (KR)

(21) Appl. No.: 14/626,943

(22) Filed: Feb. 20, 2015

(30) Foreign Application Priority Data
Apr. 3, 2014 (KR) 10-2014-0039937

(51) Int. Cl. H04L 12/863; H04L 12/825; H04L 12/26

(52) U.S. Cl. CPC H04L 47/623; H04L 43/0894; H04L 47/25

(57) ABSTRACT

Provided are a packet switch system in which an input module and an output module measure a buffer state and a packet delivery rate to control traffic, regardless of a size or a function of a switch fabric, and a traffic control method thereof. The packet switch system includes an input unit including a plurality of input modules, an output unit including a plurality of output modules, and a switch fabric including a plurality of switch components and configured to receive a packet delivered from the input unit and deliver the received packet to the output unit, wherein each of the input module includes: a plurality of virtual output queues (VOQs); and an access controller configured to selectively output packets stored in the plurality of VOQs in a weighted round robin (WRR) manner.

### CROSS-REFERENCE TO RELATED APPLICATIONS

This application claims priority under 35 U.S.C. §119 to Korean Patent Application No. 10-2014-0039937, filed on Apr. 03, 2014, the disclosure of which is incorporated herein by reference in its entirety.

### TECHNICAL FIELD

The present invention relates to a packet switch system and a traffic control method thereof, and more particularly, to a packet switch system in which an input module and an output module measure a buffer state and a packet delivery rate to control traffic, regardless of a size or a function of a switch fabric, and a traffic control method thereof.

### BACKGROUND

Recently, in line with the rapid growth of Internet services, capacity of packet switches in packet network nodes has also been actively increased on the same scale.

In particular, due to various exploding servers providing services, data centers on which packet data is concentrated require peta-level mass packet switches, as well as tens to hundreds of tera-level switches.

However, in case of packet switches, switch components need to be controlled one by one such that packets may not collide with each other during a switching process. Also, traffic collision should not occur in an input module and an output module due to excessive inflow of packets.

However, an increase in capacity of switches exponentially increases the number of switch components, which leads to a further increase in complexity of controlling, making it difficult to perform real-time controlling. In particular, massive packet switching of tens to hundreds of tera-level or higher is not controllable with existing methods.

FIG. 1 is a view illustrating a traffic control method in a packet switch system of medium-level capacity.

Referring to FIG. 1, a packet is output from an input module 10 and delivered to an output module 30 through a switch fabric 20. Here, the switch fabric 20 includes a plurality of switch components 21 and an arbiter 23.

The arbiter 23 of the switch fabric 20 controls the switch component 21 to prevent collision between packets during a packet switching process and also controls the input module 10 and the output module 20 to prevent packet collision due to excessive inflow of traffic.

Thus, the switch fabric 20 and the input and output modules 10 and 30 closely interwork to control system traffic. However, if capacity of the switch fabric 20 increases to tera level or higher, it is impossible to control traffic through close interworking therebetween in real time.

### SUMMARY

Accordingly, the present invention provides a packet switch system in which an input module and an output module measure a buffer state and a packet delivery rate to control traffic, regardless of a size or a function of a switch fabric, and a traffic control method thereof.

In one general aspect, a packet switch system includes: an input unit including a plurality of input modules; an output unit including a plurality of output modules; and a switch fabric including a plurality of switch components and configured to receive a packet delivered from the input unit and deliver the received packet to the output unit, wherein each of the input module includes: a plurality of virtual output queues (VOQs); and an access controller configured to selectively output packets stored in the plurality of VOQs in a weighted round robin (WRR) manner.

The input module may determine an output module through which a packet input from the outside of the packet switch system is to be output from the system, and store the packet in a VOQ corresponding to the output module.

The access rate controller, which selects one of the plurality of VOQs in the WRR manner and outputs a packet stored in the selected VOQ, may measure amounts of packets stored in the VOQs, and when a VOQ stores packets equal to or greater than a storage threshold value, the access rate controller may increase a weight value of the corresponding VOQ such that selection frequency of the corresponding VOQ is increased and thus the corresponding packets can be output at a faster rate.

When the amount of packets stored in the VOQ having the increased weight value is equal to or smaller than a storage threshold value, the access rate controller may restore the weight value to the original value.

Each of the output modules may include a rate measuring unit configured to measure a delivery rate of packets input from each of the input modules, and deliver a backpressure signal 1 to an access rate controller of an input module which has sent a packet at a rate higher than a rate threshold value when a packet delivery rate of the input module is equal to or greater than the rate threshold value.

The access rate controller may receive the backpressure signal 1 and adjust a weight value of the VOQ by reflecting the backpressure signal 1.

When adjusting the weight value of the VOQ, the access rate controller may reduce the weight value of the VOQ corresponding to the output module which has sent the backpressure signal 1, and operate a timer 1.

When the backpressure signal 1 is not received, the access rate controller may determine whether the timer 1 is 0, and when the timer 1 is not 0, the access rate controller may reduce the timer 1 by 1 and increase the weight value of the corresponding VOQ by a value obtained by dividing the reduced weight value by an initial set value of the timer 1 (which corresponds to a restoration value of one step) in order to recover the weight value reduced as the backpressure signal 1 was received, by one step each time.

The output module may include a buffer configured to store a packet delivered from the input module, measure an amount of stored packets, and deliver a backpressure signal 2 to the access rate controller of every input module when the amount of stored packets is equal to or greater than a storage threshold value.

The access rate controller may receive the backpressure signal 2, and adjust a weight value of the VOQ by reflecting the backpressure signal 2.

When adjusting the weight value of the VOQ, the access rate controller may reduce a weight value of a VOQ corresponding to the output module which has sent the backpressure signal 2, and operate a timer 2.

When the backpressure signal 2 is not received, the access rate controller may determine whether the timer 2 is 0, and when the timer 2 is not 0, the access rate controller may reduce the timer 2 by 1 and increase the weight value of the corresponding VOQ by a value obtained by dividing the reduced weight value by an initial set value of the timer 2 (which corresponds to a restoration value of one step) in order to recover the weight value reduced as the backpressure signal 2 was received, by one step each time.

In another general aspect, a traffic control method of a packet switch system includes: storing a packet input to an input module in a virtual output queue (VOQ) corresponding to an output module to which the input packet is to be delivered, and selectively outputting packets stored in a plurality of VOQs in a weighted round robin (WRR) manner; measuring, by an input module, an amount of packets stored in the VOQ, while storing the input packet, and comparing the measured amount of packets with a storage threshold value to determine whether the measured amount of packets is equal to or greater than the storage threshold value; when the amount of stored packets is equal to or greater than the storage threshold value, increasing a weight value of a corresponding VOQ; and when a delivery rate of a packet delivered from the input module to the output module is equal to or greater than a rate threshold value, adjusting a weight value of a VOQ depending on whether a backpressure signal 1 delivered from the output module is received.

When the amount of packets stored in the VOQ is smaller than the storage threshold value, in case of the VOQ having a weight value increased as the amount of stored packets was equal to or greater than the storage threshold value in a previous cycle, the weight value may be reduced by the increased weight value.

In the adjusting of a weight value of a VOQ depending on whether the backpressure signal 1 is received, when the backpressure signal 1 is received, the weight value of a VOQ corresponding to an output module which has sent the backpressure signal 1 may be reduced and a timer 1 may be operated.

In the adjusting of a weight value of a VOQ depending on whether the backpressure signal 1 is received, when the backpressure signal 1 is not received, whether the timer 1 is 0 may be determined, and when the timer 1 is not 0, the timer 1 may be reduced by 1 and the weight value of the corresponding VOQ may be increased by a value obtained by dividing the reduced weight value by an initial set value of the timer 1 (which corresponds to a restoration value of one step) in order to recover the weight value reduced as the backpressure signal 1 was received, by one step each time.

The method may further include: when an amount of packets stored in the buffer of the output module is equal to or greater than a storage threshold value, adjusting the weight value of the VOQ depending on whether a backpressure signal 2 delivered from the output module to every input module is received, after the adjusting of the weight value of the VOQ depending on whether the backpressure signal 1 is received.

In the adjusting of the weight value of the VOQ depending on whether the backpressure signal 2 is received, when the backpressure signal 2 is received, a weight value of a VOQ corresponding to the output module which has sent the backpressure signal 2 may be reduced and a timer 2 may be operated.

In the adjusting of a weight value of a VOQ depending on whether the backpressure signal 2 is received, when the backpressure signal 2 is not received, whether the timer 2 is 0 may be determined, and when the timer 2 is not 0, the timer 2 may be reduced by 1 and the weight value of the corresponding VOQ may be increased by a value obtained by dividing the reduced weight value by an initial set value of the timer 2 (which corresponds to a restoration value of one step) in order to recover the weight value reduced as the backpressure signal 2 was received, by one step each time.

Other features and aspects will be apparent from the following detailed description, the drawings, and the claims.

### BRIEF DESCRIPTION OF THE DRAWINGS

FIG. 1 is a view illustrating a traffic control method in the related art packet switch system having medium capacity.

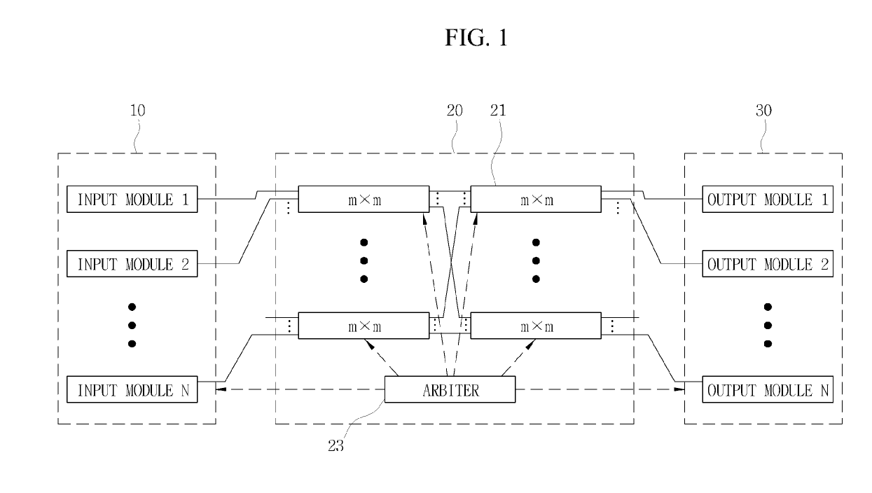

FIG. 2 is a view illustrating a configuration of the packet switch system according to an embodiment of the present invention.

FIG. 3 is a view illustrating a configuration of a single input module in the packet switch system according to an embodiment of the present invention.

FIG. 4 is a view illustrating a configuration of a single output module in the packet switch system according to an embodiment of the present invention.

FIG. 5 is a flow chart illustrating a traffic control method of an input module of the packet switch system according to an embodiment of the present invention.

FIG. 6 is a flow chart illustrating a traffic control method of an output module of the packet switch system according to an embodiment of the present invention.

### DETAILED DESCRIPTION OF EMBODIMENTS

Hereinafter, embodiments of the present invention will be described in detail to be easily embodied by those skilled in the art with reference to the accompanying drawings. In the drawings, the sizes or shapes of elements may be exaggeratedly illustrated for clarity and convenience of description. Moreover, the terms used henceforth have been defined in consideration of the functions of the present invention, and may be altered according to the intent of a user or operator, or conventional practice. Therefore, the terms should be defined on the basis of the entire content of this specification.

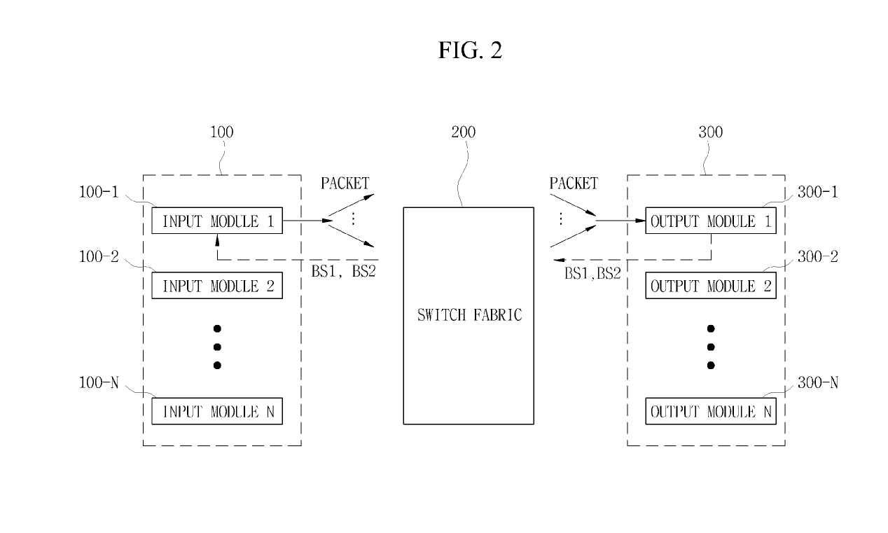

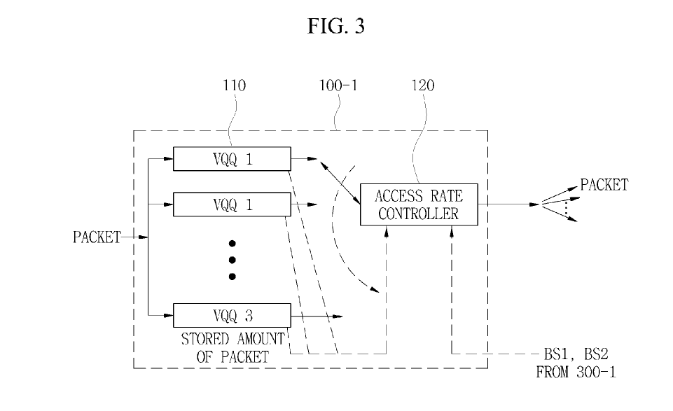

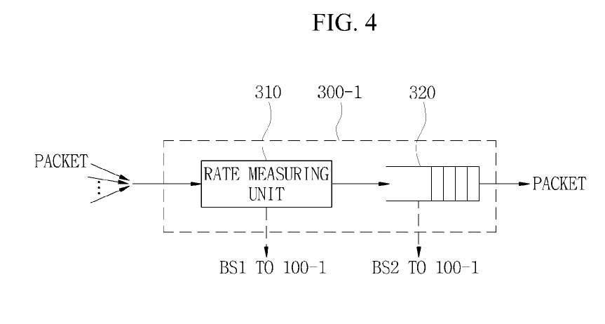

FIG. 2 is a view illustrating a configuration of the packet switch system according to an embodiment of the present invention, FIG. 3 is a view illustrating a configuration of a single input module in the packet switch system according to an embodiment of the present invention, and FIG. 4 is a view illustrating a configuration of a single output module in the packet switch system according to an embodiment of the present invention. Here, in FIGS. 2 to 4, signal flows are illustrated together with the configurations.

Referring to FIGS. 2 to 4, a packet switch system according to an embodiment of the present invention includes an input unit 100 including a plurality of input modules 100-1 to 100-N, a switch fabric 200, and an output unit 300 including a plurality of output modules 300-1 to 300-N.

The plurality of input modules 100-1 to 100-N constituting the input unit 100 have the same structure and execute the same function, and the plurality of output modules 300-1 to 300-N constituting the output unit 300 also have the same structure and execute the same function. Thus, hereinafter, a single input module 100-1 and a single output module 300-1 will be mainly described.

The switch fabric 200 is a general switch fabric including a plurality of switch components and delivering a packet input from the input unit 100 to the output unit 200, and thus, a detailed description hereof will be omitted.

In the packet switch system according to an embodiment of the present invention, packet traffic controlling is performed by each of the input modules and each of the output modules, rather than by the switch fabric 200.

Referring to FIG. 3, the single input module 100-1 may include a plurality of virtual output queues (VOQs) 110 and an access rate controller 120.

The plurality of VOQs 110 are matched to output modules 300-1 to 300-N, respectively. Namely, packets stored in the first VOQ 110 are those to be delivered to the output module 300-1.

The plurality of VOQs 100 are first-in first-output (FIFO) memories which operate independently, and packets input to the VOQs are stored in input order and output in the corresponding order.

The access rate controller 120 measures an amount of packets stored in the plurality of VOQs 110 by recognize it all the time.

The access rate controller 120 selects one of the plurality of VOQs 110 in a weighted round robin manner and outputs packets stored in the selected VOQ.

Namely, the access rate controller 120 selects the plurality of VOQs 110 of the input module 100-1 according to weight values by turns to output packets stored in the VOQS 110.

Here, the access rate controller 120 gives a weight value to each of the VOQs 110 and provides higher frequency to a VOQ 110 having a higher weight value to output packets thereof at a higher rate.

Since the access rate controller 120 has already measured and knows the amount of packets stored in the plurality of VOQs 110, the access rate controller 120 adjusts the amount of packets output from the plurality of VOQs 110 by weight values.

Thus, base on the scheme in which a VOQ storing a large amount of packets is more frequently selected and packets thereof are promptly output, when packets to be delivered to a certain output module is large in the packet switch system, the access rate controller 120 allows the large amount of packets to be delivered to the corresponding output module.

Also, the access rate controller 120 receives backpressure signals BS1 and BS2 delivered from the output module 300-1 and adjusts weight values of the plurality of VOQs 110 by reflecting the received backpressure signals BS1 and BS2.

Namely, reflecting the backpressure signals BS1 and BS2 delivered from the output module 300-1, the access rate controller 120 selects the VOQ 110 corresponding to the output module which has sent the backpressure signal 1 BS1, with smaller frequency.

When the backpressure signal 1 BS1 is received, the access rate controller 120 reduces a weight value of the VOQ corresponding to the output module which has transmitted the backpressure signal 1 BS1 and sets and operates a timer 1 for recovering the weight value when a predetermined period of time has lapsed.

Also, when the backpressure signal 1 BS1 is not received, the access rate controller 120 determines whether the timer 1 is 0, and when the timer is not 0, the access rate controller 120 reduces the timer 1 by 1.

In order to recover the weight value reduced as the backpressure signal 1 BS1 was received in a previous cycle, by one step for each time, the access rate controller 120 increases the weight value of the corresponding VOQ by a value obtained by dividing the reduced weight value by an initial set value of the timer 1, which corresponds to one step.

In this case, when the timer 1 is 0, it means that the weight value reduced according to the backpressure signal 1 BS1 has already been restored to the original value, and thus, the access rate controller 120 maintains the current weight value as is.

Meanwhile, when the backpressure signal 2 BS2 is received, the access rate controller 120 reduces a weight value of a VOQ corresponding to an output module which has transmitted the backpressure signal 2, and sets and operates a timer 2.

Also, when the backpressure signal 2 BS2 is not received, the access rate controller 120 determines whether the timer 2 is 0. When the timer 2 is not 0, the access rate controller 120 reduces the timer 2 by 1.

In order to recover the weight value reduced as the backpressure signal 2 BS2 was received in the previous cycle by one step each time, the access rate controller 120 increases the weight value of the corresponding VOQ by a value obtained by dividing the reduced weight value by an initial set value of the timer 2, which corresponds to a one step recovery value.

In this case, when the timer 2 is 0, it means that the weight value reduced according to the backpressure signal 1 BS1 has already been restored to the original value, and thus, the access rate controller 120 maintains the current weight value as is.

Also, for quality of service (QoS), a class queue may be provided in each of the VOQs 110. Namely, in each of the VOQs 110, queues exist by class, and classes of the queues are determined according to priorities. Thus, a packet in a queue having a high priority class is selected as an output packet of a corresponding VOQ. A general method for processing class queues is used, and thus, a detailed description thereof will be omitted.

Referring to FIG. 4, a single output module 300-1 may include a rate measuring unit 310 and a buffer 320.

The rate measuring unit 310 measures a delivery rate of an input packet according to each input module which has transmitted a packet, and compares the measured rate value with a pre-set rate threshold value. When the measured delivery rate value of the packet is equal to or greater than the pre-set rate threshold value according to the comparison result, the rate measuring unit 310 delivers the backpressure signal 1 BS1 to the input module which has transmitted the corresponding packet. Here, the backward direction refers to a direction opposite the direction in which the packet has been delivered.

The buffer 320 is a FIFO memory in which the packet is temporarily stored before being finally output from the single output module 300-1.

Here, the buffer 320 measures an amount of packets stored therein and compares the measured amount of packets with a pre-set storage threshold value. When the measured amount of packets is equal to or greater than the storage threshold value according to the comparison result, the buffer 320 delivers the backpressure signal 2 BS2 to every input module.

Thus, to sum up, the single output module 300-1 measures a packet input rate to output the backpressure signal 1 BS1, measures an amount of stored packets to output the backpressure signal 2 BS2, and the backpressure signal 1 BS1 and the backpressure signal 2 BS2 are delivered to a corresponding input module.

The buffer 320 includes a plurality of class queues such that a packet stored in a class queue having a high priority is first output.

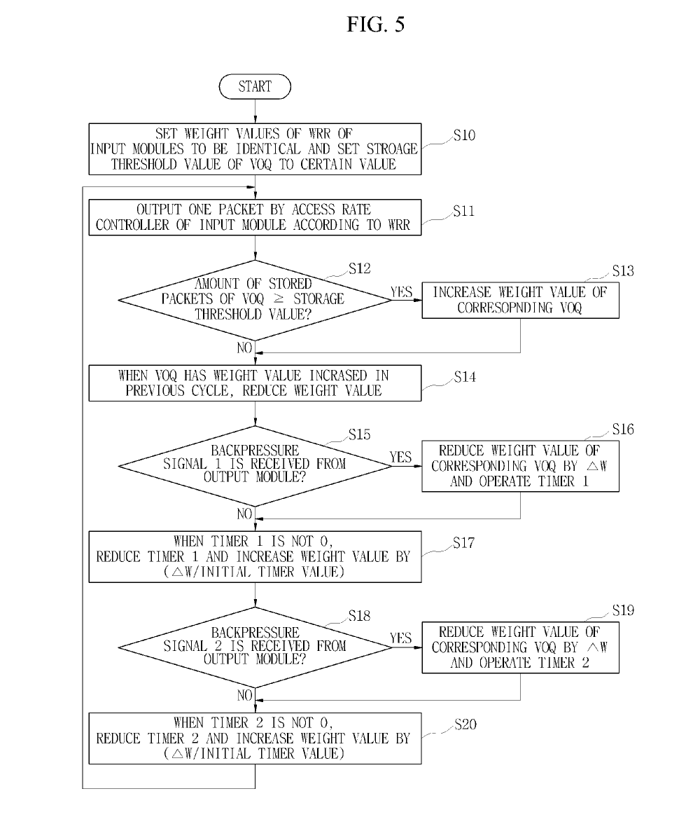

FIG. 5 is a flow chart illustrating a traffic control method of an input module of the packet switch system according to an embodiment of the present invention.

Referring to FIG. 5, in the weighted round robin (WRR) scheme of the input module 100-1, the same weight value is set for all the VOQs 110 at an initial stage, and the same storage threshold value is set for all the VOQs 110 in step S10.

The access rate controller 120 of the input module 100-1 selects one of the plurality of VOQs 110 in the weighted round robin manner, and outputs a packet stored in the selected VOQ in step S11. All the VOQs 110 has the same weight value at the initial stage, and as an operating cycle is repeated, the weight value continues to be changed.

Over a packet input from the outside, the input module 100-1 determines an output module to which the input packet is to be delivered, and stores the input packet in the VOQ 110 corresponding to the output module. Also, the input module 100-1 measures an amount of packets stored in the plurality of VOQs 110 and determines whether the measured amount of packets exceed a pre-set threshold value in step S12.

Here, when the amount of stored packets is greater than the storage threshold value (for example, 50% of capacity of the VOQ) in step 12 (S12: Yes), the input module 100-1 increases the weight value of the corresponding VOQ 110 in step S13, and when the amount of stored packets is smaller than the threshold value in step S12 (S12: No) and the weight value in the previous cycle is an increased weight value, the input module 100-1 reduces the weight value to original value in step S14.

Here, preferably, the magnitude of the increased weight value and the magnitude of the reduced weight value are set to be equal.

Accordingly, the input module 100-1 allows the VOQ 110, to which a large amount of packets are input due to increased traffic, to be selected with greater frequency such that a larger amount of packets may be transmitted to an output module linked to a node with large traffic.

Next, depending on whether the backpressure signal 1 BS1 and the backpressure signal 2 BS2 delivered from the output module 300-1 is received, the input module 100-1 changes a weight value of a VOQ.

In detail, the input module 100-1 determines whether the backpressure signal 1 BS1 is received from the output module 300-1 in step S15, and when the backpressure signal 1 is received (step 15: YES), the input module 100-1 reduces a weight value of the corresponding VOQ in step S16.

Here, the input module 100-1 operates the timer 1, while reducing the weight value of the corresponding VOQ. The timer 1 counts down each time an operation of the input module 100-1 repeats one cycle, and eventually, the reduced weight value is to be returned to its original value by increasing the weight value one step each time.

When it is determined that the backpressure signal 1 BS1 has not been received (S15: No), the input module 100-1 determines whether the timer 1 is 0. When the timer 1 is not 0, the input module 100-1 reduces the timer 1 by 1 and increases the weight value of the corresponding VOQ, which was reduced as the backpressure signal 1 BS1 received in a previous cycle, by one step (a value obtained by dividing the reduced weight value by an initial timer set value) in step S17.

Namely, when the weight value of the corresponding VOQ was reduced by ΔW according to the backpressure signal 1 BS1 in the previous cycle and the timer T was set to T at that time and counts down, the weight value is increased by ΔW/T, i.e., by one step, in the current cycle.

Thus, the reduced amount of the weight value due to the backpressure signal 1 BS1 is gradually increased in stages through several cycles so as to be returned to the original value.

Thereafter, the input module 100-1 determines whether the backpressure signal 2 BS2 is received from the output module 300-1 in step S18. When the backpressure signal 2 BS2 is received (S18: Yes), the input module 100-1 reduces the weight value of the corresponding VOQ in step S19.

Here, while reducing the weight value of the corresponding VOQ, the input module 100-1 operates the timer 1. The timer 1 counts down each time an operation of the input module 100-1 repeats one cycle, and eventually, the reduced weight value is to be returned to its original value by increasing the weight value one step each time.

When it is determined that the backpressure signal 2 BS2 has not been received (S18: No), the input module 100-1 determines whether the timer 2 is 0. When the timer 2 is not 0, the input module 100-1 reduces the timer 2 by 1 and increases the weight value of the corresponding VOQ, which was reduced as the backpressure signal 1 BS1 received in a previous cycle, by one step (a value obtained by dividing the reduced weight value by an initial timer set value) in step S20.

Namely, when the weight value of the corresponding VOQ was reduced by ΔW according to the backpressure signal 2 BS2 in the previous cycle and the timer T was set to T at that time and counts down, the weight value is increased by ΔW/T, i.e., by one step, in the current cycle.

Thus, the reduced amount of the weight value due to the backpressure signal 2 BS2 is gradually increased in stages through several cycles so as to be returned to the original value.

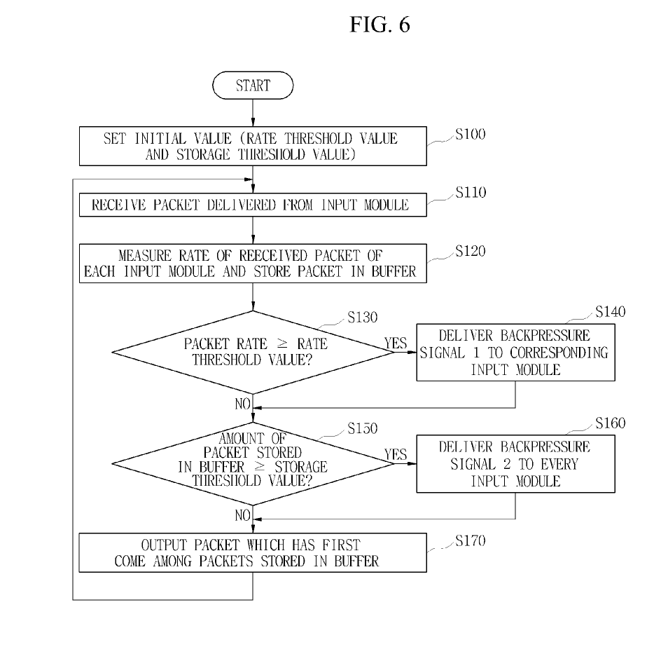

FIG. 6 is a flow chart illustrating a traffic control method of an output module of the packet switch system according to an embodiment of the present invention.

Referring to FIG. 6, the output module 300-1 sets an initial value. Here, a packet delivery rate threshold value and a packet storage threshold value of a buffer are set in step S100.

A packet delivered from the input module 100-1 is received in step S110.

While receiving the packet, the output module 300-1 measures rates of received packets of input modules which had sent the packets, and stores the measured rates of packets in a buffer in step S120. Here, when a packet delivery rate is equal to or greater than a pre-set rate threshold value (S130: Yes), the output module 300-1 delivers a backpressure signal 1 BS1 to the corresponding input module in step S140.

Also, when the packet delivery rate is lower than the pre-set rate threshold value (S130: No), or after the backpressure signal 1 BS1 is delivered to the corresponding input module in step S140, the output module 300-1 measures an amount of packets stored in the buffer in step S150. When the measured amount of packets is equal to or greater than a pre-set storage threshold value (S150: Yes), the output module 300-1 delivers a backpressure signal 2 BS2 to every input module in step S160.

When the measured amount of packets is smaller than the pre-set storage threshold value (S150: No), or after the backpressure signal 2 BS2 is delivered to every input module in step S160, the output module 300-1 outputs a packet which had first come (the oldest packet), among the packets stored in the buffer, in step S170, and conducts an operation of a next cycle in step S110.

Namely, in the packet switch system according to an embodiment of the present invention, an amount of packets output from an input module is adjusted, while adjusting a weight value of a VOQ of an input module according to an amount of packets stored in the VOQ of the input module, a delivery rate of a packet delivered to an output module, and an amount of packets stored in a buffer of the output module.

Thus, since traffic of the packet switch system can be controlled by exchanging backpressure signals for controlling a traffic rate between the input module and the output module regardless of the switch fabric in the packet switch system, the present invention can be applied to a packet switch system including a mass switch fabric.

According to embodiments of the present invention, traffic of the packet switch system can be controlled b exchanging a signal for controlling a rate of traffic between an input module and an input module, regardless of a switch fabric in the packet switch system having a mass switch fabric.

Thus, since the input module and the output module measure a traffic rate and a packet buffer state and control traffic based on the measured traffic rate and packet buffer state, they can control traffic regardless of capacity of the switch fabric.

The packet switch system and the traffic control method thereof have been described according to the embodiments, but the scope of the present invention is not limited to a specific embodiment. The present invention may be corrected and modified within the technical scope obvious to those skilled in the art.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A packet switch system comprising:
an input unit including a plurality of input modules;
an output unit including a plurality of output modules; and
a switch fabric including a plurality of switch components and configured to receive a packet delivered from the input unit and deliver the received packet to the output unit,
wherein each of the input module comprises:
a plurality of virtual output queues (VOQs); and
an access controller configured to selectively output packets stored in the plurality of VOQs in a weighted round robin (WRR) manner.

2. The packet switch system of claim 1, wherein the access rate controller measures amounts of packets stored in the VOQs, and when a VOQ stores packets equal to or greater than a storage threshold value, the access rate controller increases a weight value of the corresponding VOQ such that selection frequency of the corresponding VOQ is increased and thus the corresponding packets can be output at a faster rate.

3. The packet switch system of claim 2, wherein when the amount of packets stored in the VOQ having the increased weight value is equal to or smaller than a storage threshold value, the access rate controller restores the weight value to the original value.

4. The packet switch system of claim 1, wherein each of the output modules comprises a rate measuring unit configured to measure a delivery rate of packets input from each of the input modules, and deliver a backpressure signal 1 to an access rate controller of an input module which has sent a packet at a rate higher than a rate threshold value when a packet delivery rate of the input module is equal to or greater than the rate threshold value.

5. The packet switch system of claim 4, wherein the access rate controller receives the backpressure signal 1 and adjusts a weight value of the VOQ by reflecting the backpressure signal 1.

6. The packet switch system of claim 5, wherein when the backpressure signal 1 is received, the access rate controller reduces the weight value of the VOQ corresponding to the output module which has sent the backpressure signal 1, and operates a timer 1.

7. The packet switch system of claim 6, wherein when the backpressure signal 1 is not received, the access rate controller determines whether the timer 1 is 0, and when the timer 1 is not 0, the access rate controller reduces the timer 1 by 1 and increases the weight value of the corresponding VOQ by a value obtained by dividing the reduced weight value by an initial set value of the timer 1 in order to recover the weight value reduced as the backpressure signal 1 was received, by one step each time.

8. The packet switch system of claim 1, wherein the output module comprises a buffer configured to store a packet delivered from the input module, measure an amount of stored packets, and deliver a backpressure signal 2 to the access rate controller of every input module when the amount of stored packets is equal to or greater than a storage threshold value.

9. The packet switch system of claim 8, wherein the access rate controller receives the backpressure signal 2, and adjusts a weight value of the VOQ by reflecting the backpressure signal 2.

10. The packet switch system of claim 9, wherein when the backpressure signal 2 is received, the access rate controller reduces a weight value of a VOQ corresponding to the output module which has sent the backpressure signal 2, and operates a timer 2.

11. The packet switch system of claim 10, wherein when the backpressure signal 2 is not received, the access rate controller determines whether the timer 2 is 0, and when the timer 2 is not 0, the access rate controller reduces the timer 2 by 1 and increases the weight value of the corresponding VOQ by a value obtained by dividing the reduced weight value by an initial set value of the timer 2 in order to recover the weight value reduced as the backpressure signal 2 was received, by one step each time.

12. A traffic control method of a packet switch system, the traffic control method comprising:
storing a packet input to an input module in a virtual output queue (VOQ) corresponding to an output module to which the input packet is to be delivered, and selectively outputting packets stored in a plurality of VOQs in a weighted round robin (WRR) manner;
measuring, by an input module, an amount of packets stored in the VOQ, while storing the input packet, and comparing the measured amount of packets with a storage threshold value to determine whether the measured amount of packets is equal to or greater than the storage threshold value;
when the amount of stored packets is equal to or greater than the storage threshold value, increasing a weight value of a corresponding VOQ; and
when a delivery rate of a packet delivered from the input module to the output module is equal to or greater than a rate threshold value, adjusting a weight value of a VOQ depending on whether a backpressure signal 1 delivered from the output module is received.

13. The traffic control method of claim 12, wherein when the amount of packets stored in the VOQ is smaller than the storage threshold value, in case of the VOQ having a weight value increased as the amount of stored packets was equal to or greater than the storage threshold value in a previous cycle, the weight value is reduced by the increased weight value.

14. The traffic control method of claim 12, wherein, in the adjusting of a weight value of a VOQ depending on whether the backpressure signal 1 is received, when the backpressure signal 1 is received, the weight value of a VOQ corresponding to an output module which has sent the backpressure signal 1 is reduced and a timer 1 is operated.

15. The traffic control method of claim 12, wherein, in the adjusting of a weight value of a VOQ depending on whether the backpressure signal 1 is received, when the backpressure signal 1 is not received, whether the timer 1 is 0 is determined, and when the timer 1 is not 0, the timer 1 is reduced by 1 and the weight value of the corresponding VOQ is increased by a value obtained by dividing the reduced weight value by an initial set value of the timer 1 in order to recover the weight value reduced as the backpressure signal 1 was received, by one step each time.

16. The traffic control method of claim 12, further comprising:
when an amount of packets stored in the buffer of the output module is equal to or greater than a storage threshold value, adjusting the weight value of the VOQ depending on whether a backpressure signal 2 delivered from the output module to every input module is received, after the adjusting of the weight value of the VOQ depending on whether the backpressure signal 1 is received.

17. The traffic control method of claim 16, wherein, in the adjusting of the weight value of the VOQ depending on whether the backpressure signal 2 is received, when the backpressure signal 2 is received, a weight value of a VOQ corresponding to the output module which has sent the backpressure signal 2 is reduced and a timer 2 is operated.

18. The traffic control method of claim 16, wherein, in the adjusting of a weight value of a VOQ depending on whether the backpressure signal 2 is received, when the backpressure signal 2 is not received, whether the timer 2 is 0 is determined, and when the timer 2 is not 0, the timer 2 is reduced by 1 and the weight value of the corresponding VOQ is increased by a value obtained by dividing the reduced weight value by an initial set value of the timer 2 in order to recover the weight value reduced as the backpressure signal 2 was received, by one step each time.
